(19) United States
(12) Patent Application Publication
(10) Pub. No.: US 2014/0355193 A1
(43) Pub. Date: Dec. 4, 2014

(54) Portable Computer Keyboard Assembly

(71) Applicant: Dale McPhee PURCOCKS, Chepstow (GB)

(72) Inventor: Dale McPhee Purcocks, Chepstow (GB)

(21) Appl. No.: 14/375,641

(22) PCT Filed: Jan. 30, 2013
(86) PCT No.: PCT/GB2013/050209

§ 371 Date: Jul. 30, 2014

(30) Foreign Application Priority Data
Jan. 30, 2012 (GB) 1201549.1

(51) Int. Cl. G06F 1/16

(52) U.S. Cl. CPC G06F 1/1656; G06F 1/1669
USPC 361/679.17

(57) ABSTRACT

A portable computer keyboard assembly comprises an input membrane assembly (10) comprising first (20) and second (22) membranes, each having an electrical circuit provided on a surface thereof and means for separating the electrical circuits of the first (20) and second (22) membranes and permitting selective electrical connection therebetween at discrete contact nodes. The input membrane assembly (10) is configured to be secured to a portable computer. A keypad (8) is also provided which includes a plurality of keys and a support member for movably supporting the keys such that they are movable between a first position and a second operable position. The keys are arranged to correspond in position to the location of the contact nodes on the input assembly (10), and the keypad (8) is configured to be located relative to the input membrane (10) such that movement of the keys to the operative positions causes said selective electrical connection between the circuits of the first (20) and second (22) membranes at the corresponding contact nodes. Releasable securing means (77) is provided for releasably securing the keypad (8) in location relative to the input membrane assembly (10) and relative to the portable computer to which the input membrane assembly (10) is secured. The releasable securing means (77) also permits the keypad (8) to be released from its position relative to the input assembly (10) for cleaning and/or repair.

The present invention relates to a keyboard assembly for a portable computing device such as a laptop and in particular to a removable and waterproof laptop keyboard assembly.

Keyboards provide an interface between a computer and a user, with the user providing input commands to the computer via the keyboard. A computer keyboard essentially comprises a series of switches connected to a microprocessor that monitors the state of each switch and initiates a specific response to a change in that state. For desktop computers the keyboard is provided as a stand alone component remote from the computer. In portable laptop and notebook computers the keyboard is an integrated part of the computer unit.

A typical laptop keyboard assembly of the prior art is described in U.S. Pat. No. 5,769,210. The keyboard of US '210 comprises a plurality of keys each supported on a scissor mechanism configured to return the key to a rest position. The scissor mechanisms are connected to a rigid plate which supports the mechanisms. Beneath the support plate is a plurality of elastic dome members corresponding to the each of the keys and located directly above a membrane switch assembly. Beneath the membrane switch assembly is a base plate. Depression of the keys causes downward movement of the dome members causing them to contact and actuate a corresponding switch of the membrane assembly. An electrical data connection cable extends from the membrane assembly which connects to the laptop circuitry via a corresponding socket and the keyboard assembly is secured to the laptop body through the base and clamped around its upper periphery by the upper surface of the laptop body and/or the cosmetic plate surrounding the keypad.

Laptop keyboards are essential to the functioning of the laptop, and form an integral part of the assembly. As mechanical components the keys of a laptop keyboard the keys experience frequent repeated mechanical action, and are also located at the exposed upper surface of the laptop in use they are prone to damage and contamination. As the cost of the keyboard is minimal compared to the overall cost of the laptop and its components, it is essential that the keyboard is able to be removed from the laptop for replacement or repair to avoid having to scrap the laptop for the sake of damage to a relatively inexpensive component.

In order to remove a laptop keyboard the back panel of the laptop body must first be unscrewed and removed requiring the removal of multiple screws. At least part of the upper cover of the laptop must then be removed and further screws securing the keyboard to the base from above removed. The keyboard assembly is then removed by disconnecting the data cable from the laptop and the entire keyboard assembly, including the membrane input assembly is removed from the laptop. Such removal is typically conducted for replacement or repair of the keyboard assembly.

In view of the number of steps and the requirement to remove and disconnect multiple components of the laptop, this removal process is generally only undertaken by users who are confident and competent in pc and laptop repair. It is therefore desirable to provide a laptop keyboard which is able to be removed in a simpler and more straightforward manner, thereby reducing the time and effort required and enabling less experienced users to perform the task.

The manner in which a keyboard is connected to a laptop exposes the circuitry within the laptop to liquid ingress through the gaps defined between and around the matrix of keys. It is therefore difficult to sterilise and maintain the cleanliness of a laptop keyboard due to the risk of causing damage to the laptop circuitry. Even if the keyboard is removed as described above, the exposed electrical connections of the keyboard assembly remain vulnerable to liquid ingress during cleaning. In addition, while the above described method is acceptable although not desirable for the periodic removal of a laptop keyboard for repair, cleaning and sterilisation of a keyboard must be conducted on a more frequent basis and in environments such as hospitals this may be on a daily basis. Therefore, as well as the above described arrangement being unsuitable for a keyboard which requires cleaning due to the risk of damage from liquid ingress, the above described removal method is also unsuitable for frequent removal of the keyboard due to the time and effort involved and the associated risk of damage due to constant electrical disconnection of the keyboard.

It is therefore also desirable to provide a laptop keyboard assembly which is capable of being cleaned without the risk of damage to the laptop.

In accordance with the present invention there is provided a portable computer keyboard assembly comprising an input membrane assembly comprising first and second membranes each having an electrical circuit provided on a surface thereof, and means for separating the electrical circuits of the first and second membranes and permitting selective electrical connection therebetween at discrete contact nodes, the input membrane assembly being configured to be secured to the portable computer; a keypad including a plurality of keys and a support member for movably supporting said keys such that the keys are movable between a first position and a second operable position, the keys being arranged to correspond in position to the location of the contact nodes on the input assembly, and the keypad being configured to be located relative to the input membrane such that movement of the keys to the operative positions causes said selective electrical connection between the circuits of the first and second membranes at the corresponding contact nodes; and releasable securing means for releasably securing the keypad in said location relative to the input membrane assembly and relative to the portable computer to which the input membrane assembly is secured, and for permitting said keypad to be released from its position relative to the input assembly for cleaning and/or repair.

By providing an input assembly which is both mechanically and electrically separate from the keypad assembly, with the input assembly being secured to the computer, the keypad assembly is able to be removed from the computer without requiring electrical disconnecting, and when so removed is able to be washed using a liquid without the risk of damage to electrical components which are entirely absent from the keypad.

The input membrane assembly and keypad assembly may be arranged such that when the keypad is released and removed from the securing means the input membrane assembly is able to remain secured and electrically connected to the laptop.

The releasable securing means preferably comprises clamping means. A clamping arrangement provides a convenient and quick release means of releasably securing the keypad as compared to more permanent fixings such as screws, and provides a means of positively biasing the keypad in position against the input membrane assembly to ensure optimum connection and prevent rattle or other movement of the keypad.

The securing means may comprise a quick release securing means.

The clamping means may be configured to be secured to the portable computer and comprises a clamping member which is movable between a first clamped position in which the clamping member engages and clamps the keypad in said location relative to the input membrane assembly and a second release position. The securing means preferably comprises an engagement member configured to be secured to the portable computer and configured to engage with a portion of the keypad assembly and to cooperate with the keypad assembly when so engaged to retain the keypad in said location relative to the input membrane assembly when the clamping member is in the clamped position, the keypad being able to disengage from the engagement member when the clamping member is in the release position. The engagement member thereby cooperates with the clamping member such that clamping along only one edge of the keypad is required, which simplifies the arrangement and reduces parts.

The clamping means may include actuating means configured to be manually engaged by a user to cause the clamping means to move between the clamping and release positions. The actuating means is preferably a lever which is configured to be rotated by the user and arranged such that rotation of the lever causes the clamping means to move between the clamping and release positions.

The clamping member may be rotatable between the clamped and release positions, which allows the clamping member to be actuated by a rotating lever.

The clamping member preferably comprises a lifting portion arranged such that when the clamping member is rotated to the release position the lifting portion engages and lifts the keypad to enable the keypad to be gripped for release. This advantageously ensures that the keypad is able to be effectively removed by the user once released.

The clamping means may comprise a plurality of clamping members rotatably mounted to a spindle which is actuatable to rotate the clamping members between the clamped and release positions. The multiple clamping members engage with a plurality of corresponding tabs or projections on the keypad.

In another aspect of the invention there is provided a portable computer keyboard assembly comprising an electrical connector connected to the electrical circuit of one or both of the electrical circuits of the first or second membranes and comprising a connection portion configured for electrical connection to the portable computer; a base for supporting the membrane assembly; and sealing means configured to seal the membrane assembly to the base to form a sealed unit which seals and encapsulates the electrical circuits of the membrane assembly and the connection portion of the electrical connector. In this way the keypad and the membrane assembly are electrically disconnected, as compared to assemblies of the prior art in which the membrane assembly is an integral part of the keypad, and the membrane assembly is therefore able to be sealed to the computer to provide a watertight arrangement, while the keypad is able to be mechanically disconnected and removed from the membrane assembly and the computer to which is attached for cleaning or repair.

The sealing means may define a sealing perimeter and the connection portion of the electrical connector is arranged such that it is located within the sealing perimeter to be sealed and encapsulated by the sealing means when the sealing means is sealed to the further surface. The base may includes an aperture configured to receive a connection cable to electrically connect the connection portion of the input membrane with the portable computer, the aperture being located within the sealing perimeter with access for the connection cable being achievable through the aperture from beneath the base.

The base may include one or more apertures defining drain holes which connect with corresponding channels which extend through the computer body to an external drain point to allow liquid to flow safely through the computer or laptop. Channels may be formed in the upper surface of a laptop to act as gulleys to channel liquid overflowing from the waterproof membrane assembly and avoid pooling on the upper surface of the laptop.

The portable computer keyboard assembly may further include sealing means for providing a seal between the input membrane assembly and the body of a portable computer to prevent liquid ingress into the body of the portable computer between the input membrane assembly and said body.

The input membrane assembly may further comprise a frame section which substantially surrounds the base and is configured to secure to the body of the portable computer, said frame being sealingly connected to the base of the input membrane assembly and comprising said sealing means for sealing to the body of the portable computer.

The sealing means preferably comprises a sealing gasket provided on the upper surface of the frame for engagement with the portable computer, the frame comprising connection means for connecting the frame to the portable computer body such that the gasket is clamped therebetween.

The base preferably comprises and upstanding wall portion extending about its peripheral edge including a rim portion which is secured to the frame section. The frame section is preferably bonded to the base, and further is preferably moulded to the base in a sealing manner.

The releasable securing means preferably comprises a clamping member which is movable between a first clamped position in which the clamping member engages and clamps the keypad in said location relative to the input membrane assembly and a second release position and securing means comprising an engagement member, one of the frame and the keypad assembly comprising a projection defining an engagement member and the other comprising a recess configured to receive said engagement member, the recess and projection being arranged to cooperate such that when the engagement member is received within the recess and the clamping member is in the clamped position the engagement member is locked within the recess to retain the keypad in said location relative to the input membrane assembly and when the clamping member is in the release position the engagement member is able to be removed from the recess to permit separation of the keypad from the input assembly.

In another aspect of the invention there is provided a portable computer keyboard assembly comprising a keypad including a plurality of keys movable between a first position and a second operable position; input means for converting movement of the keys to the operable position to an electrical signal; and releasable securing means arranged to be attached to the body of a portable computer and configured to releasably secure the keypad to the portable computer, the securing means being operable such that in a first condition it secures the keypad to the portable and in a second condition it allows the keypad to be removed.

In another aspect of the invention there is provided an assembly for a human interface device such as a keyboard; the input assembly comprising a keypad including a plurality of keys movable between a first position and a second operable position; input means for converting movement of the keys to the operable position to an electrical signal; and releasable securing means operable such that in a first condition it secures the keypad relative to the input membrane assembly and in a second condition it allows the keypad and the input membrane assembly to be separated. The releasable securing means preferably comprises clamping means.

The clamping means is preferably configured to be secured to the portable computer and comprises a clamping member which is movable between a first clamped position in which the clamping member engages and clamps the keypad in said location relative to the input membrane assembly and a second release position.

The securing means preferably comprises a least one engagement element configured to be secured to the portable computer and configured to engage with a portion of the keypad assembly and to cooperate with the keypad assembly when so engaged to retain the keypad in said location relative to the input membrane assembly when the clamping member is in the clamped position, the keypad being able to disengage from the engagement element when the clamping member is in the release position.

The input means preferably comprises a base plate and the clamping means comprises a frame arranged about the base plate and sealingly secured thereto the frame being arranged to receive the keypad and a portion of the frame comprising at least one recess defining said engagement element which is configured to receive a corresponding portion of the keypad to retain the keypad within the frame when the clamping member is in the clamped position.

The clamping means preferably includes actuating means configured to be manually engaged by a user to cause the clamping means to move between the clamping and release positions.

The actuating means is preferably a lever which is configured to be rotated by the user and arranged such that rotation of the lever causes the clamping means to move between the clamping and release positions. The clamping member is preferably rotatable between the clamped and release positions.

The clamping member preferably comprises a lifting portion arranged such that when the clamping member is rotated to the release position the lifting portion engages and lifts the keypad to enable the keypad to be gripped for release.

The release member is preferably arranged such that when the keypad is moved into said position relative to the input membrane assembly it engages the release member and causes the release member to rotate the clamping member to the clamped position to clamp the keypad in said position relative to the input membrane assembly.

The clamping means preferably comprises a plurality of clamping members rotatably mounted to a spindle which is actuatable to rotate the clamping members between the clamped and release positions.

In another aspect of the invention there is provided a portable computing device comprising a body section containing electronic components of said computing device; a keyboard assembly; and sealing means arranged to provide a seal between the keyboard assembly and the body section to prevent liquid ingress into the body section between the keyboard assembly and the body section. In this way damage to the electric components due to liquid ingress between the keyboard assembly and the body is prevented.

In another aspect of the invention the re is provided a portable computing device according to claim 29 wherein the keyboard assembly comprising a keypad including a plurality of keys movable between a first position and a second operable position; and an input assembly including electrical means for converting movement of the keys to the operable position to an electrical signal and a base, said input means being sealed to said base such that liquid ingress to the electrical means is prevented. The sealing means is arranged to form a seal between the base and the body section.

The body section preferably includes a cover member arranged to surround the periphery of the keyboard between the keyboard and the upper surface of the body section, the sealing means being arranged to seal at least in part against the cover member.

The input membrane assembly preferably comprises first and second membranes each having an electrical circuit provided on a surface thereof, and means for separating the electrical circuits of the first and second membranes and permitting selective electrical connection therebetween, the input membrane assembly being sealed to the base such that the first and second electrical circuits are sealed end encapsulated.

The base preferably further comprising a frame section which substantially surrounds its periphery and extends upwardly therefrom, said sealing means provided between said frame section and the body section.

The base defines a tray having a frame defining an upstanding wall about its periphery. The tray includes the input assembly and is sealed against the inside surface of the upper case of a laptop or other computing device. The tray defines a shallow sealed depression in the upper surface of the laptop case which is configured to receive the keypad in a removable manner such that the keypad can be quickly and easily fitted and removed. The quick release of the keypad is enabled by the clamping mechanism located in or along one or more edges of the frame. The input membrane assembly is sealed to the upper presenting surface of the tray or base by a covering membrane or blanket which may be one of the membranes of the membrane assembly. The sealing layer provides a waterproof cover sealed to the base under which the membrane input circuitry and any other electrical components such as LEDs, electrical connections etc are sealed. In this way the base including the input membrane is sealed and the tray arrangement is able to fill with liquid, with any excess liquid possibly overflowing and/or draining from the tray while the electronic components of the input assembly and of the laptop remain completely watertight. The keypad having no electronic or electrical components can be removed using the quick release clamping mechanism for washing and replaced easily be a user without requiring any technical skill.

The sealing means preferably comprises a sealing gasket provided on the upper surface of the frame section and the base comprises connection means for connecting the base to the body section such that the gasket is clamped between the frame section and the body section.

In another aspect of the invention there is provided a keyboard switch including a key member movable between a first position and a second operable position, input means configured to generate an electric signal in response to movement of the key member to the second position, and a resilient domed member disposed between the key member and the input means and arranged such that movement of the key member to the second position causes the dome member to compress such that a portion of the dome member engages the input means to cause the input means to generate said electrical signal, and a light source arranged to illuminate at least a portion of the dome member, wherein the domed member is formed of a resilient material including a luminescent component configured such that the domed member is caused to emit light when illuminated by the light source.

The light source is located on the opposing side of the domed member to the key member. At least a portion of the key member may be configured to permit the passage of light such that the light emitted by the domed member is visible through the key member.

The luminescent component may be a photo-luminescent additive.

The present invention will now be described by way of example only with reference to the following illustrative figures in which:

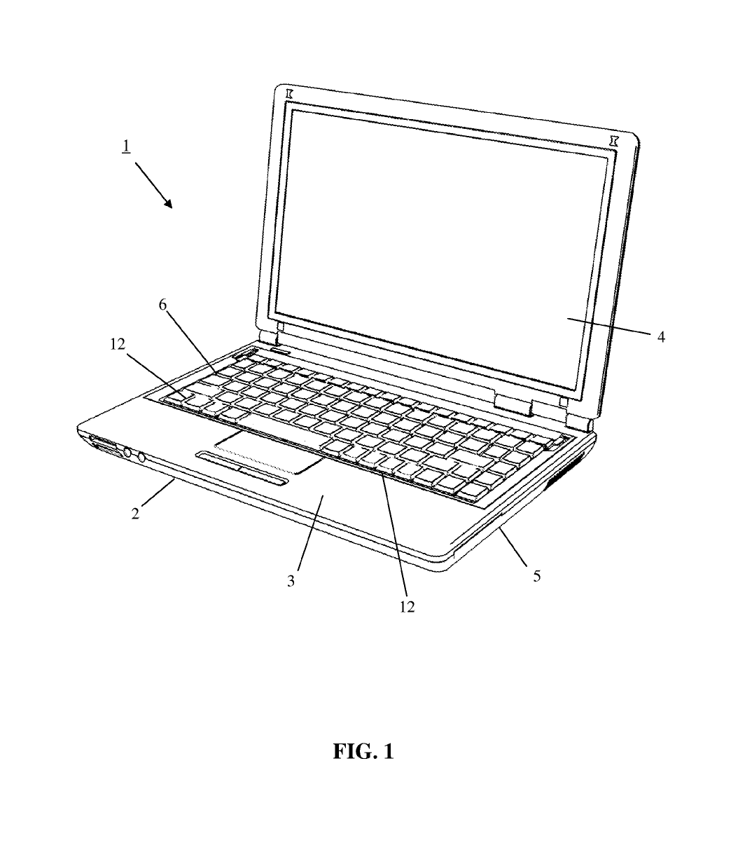

FIG. 1 shows a portable computer according to an embodiment of the present invention;

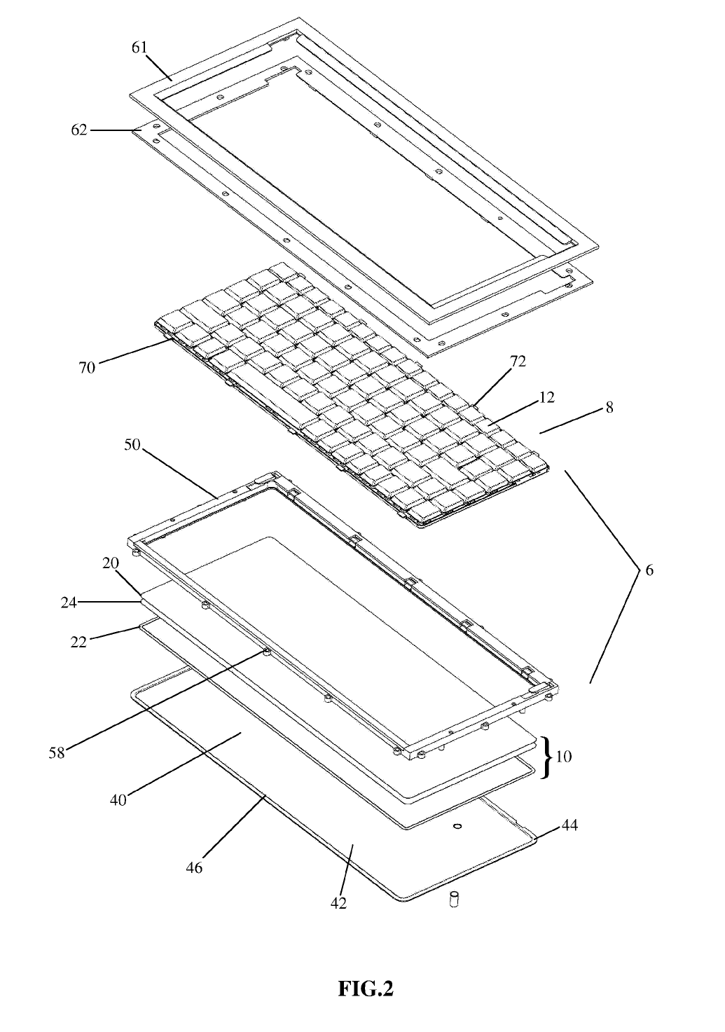

FIG. 2 is an exploded view of a keyboard assembly according to an embodiment of the present invention;

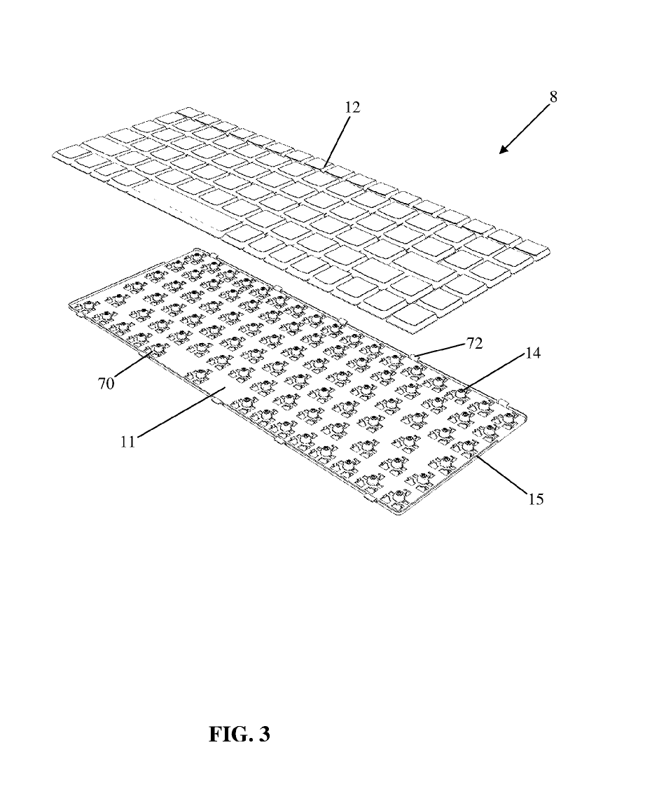

FIG. 3 is an exploded view of a keypad assembly according to an embodiment of the present invention;

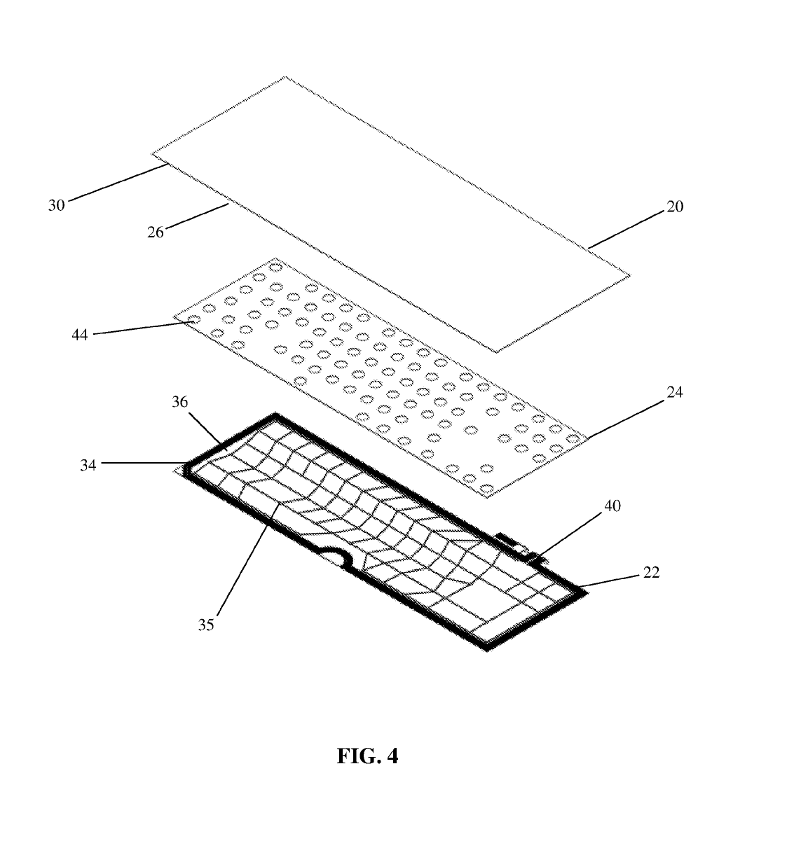

FIG. 4 is an exploded view of an input membrane assembly according to an embodiment of the present invention;

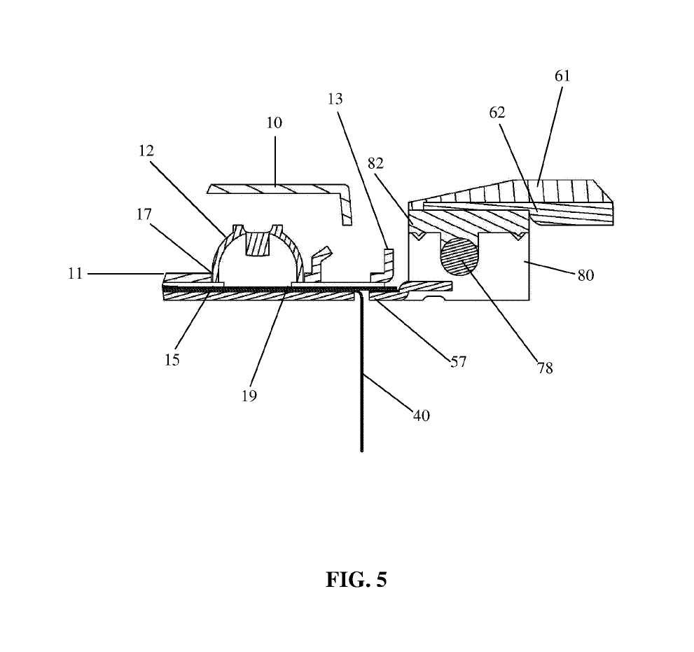

FIG. 5 is a section view of a part of a keypad and membrane assembly and a clamping frame according to an embodiment of the present invention;

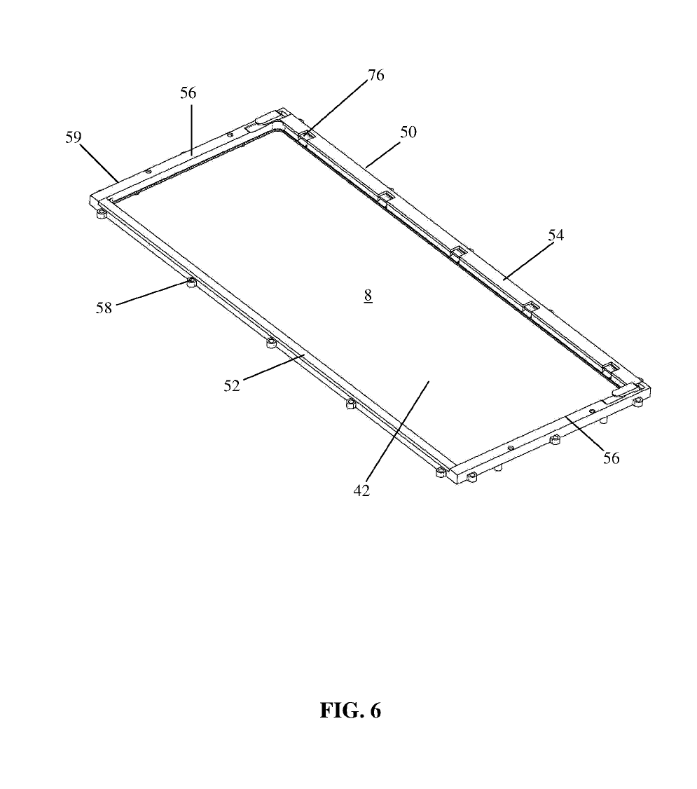

FIG. 6 is a clamping frame according to an embodiment of the present invention;

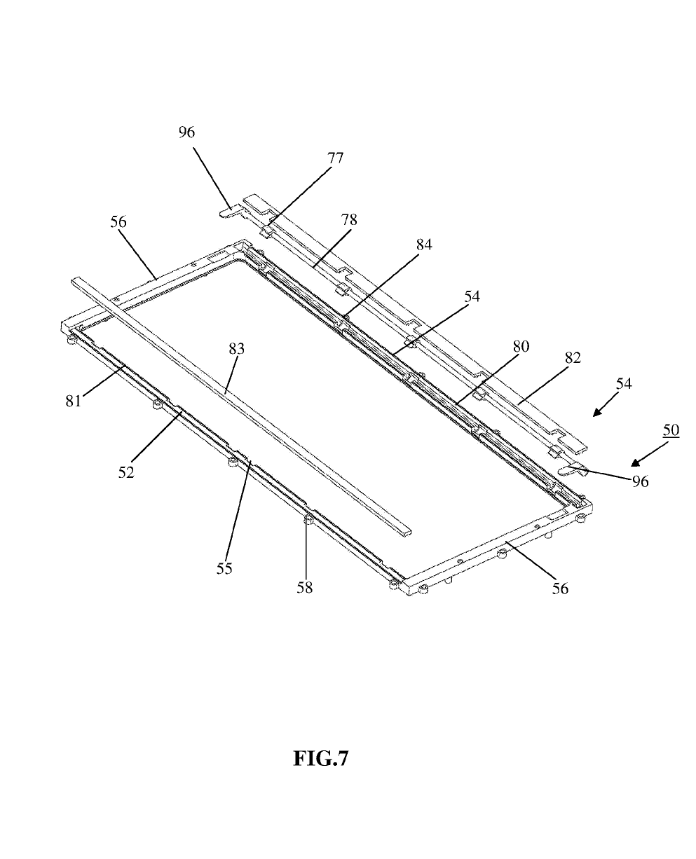

FIG. 7 is an exploded view of the frame of FIG. 5;

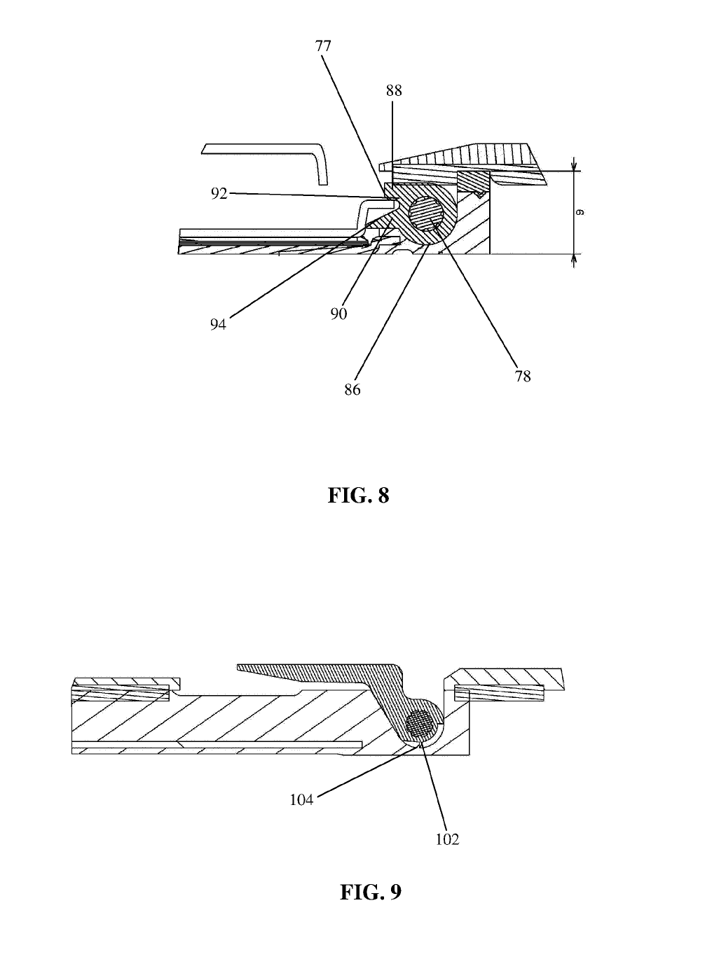

FIG. 8 is a section view of a clamping arrangement according to an embodiment of the present invention;

FIG. 9 is a section view of a clamping lever arrangement according to an embodiment of the present invention;

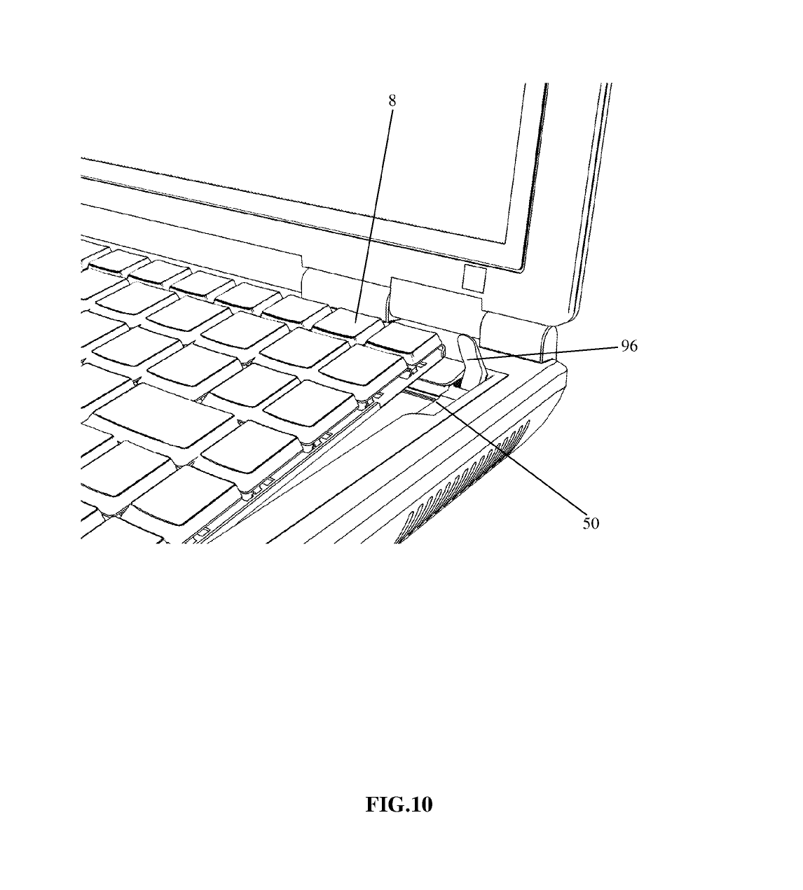

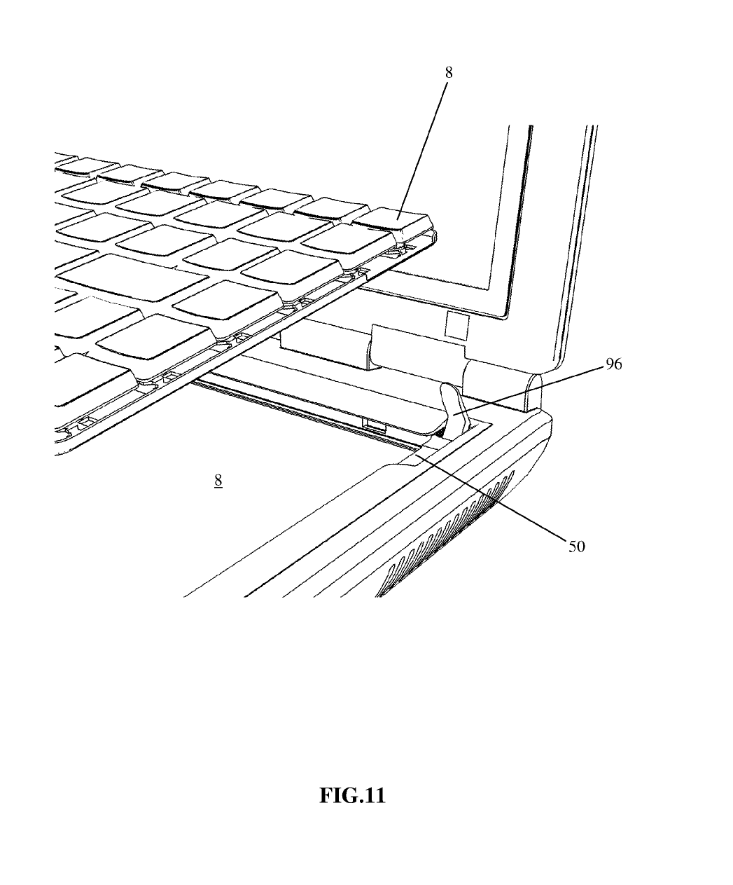

FIG. 10 is a partial view of a laptop in a release position with the keypad partially released/inserted according to an embodiment of the present invention;

FIG. 11 is a partial view of a laptop with the keypad released according to an embodiment of the present invention;

As shown in FIG. 1, a laptop 1 includes a body section 2 and a screen section 4 which are hingedly connected. The body section 2 defines a housing for containing the laptop circuitry including the processor and hard drive and includes an upper panel 3 defining the surface of the body section and a lower panel 5 defining it base. The body section 2 further contains a keyboard assembly 6. The keyboard assembly 6 provides an interface to permit the input of information to the computer by the user through activation of a plurality of switches located within the keyboard 6.

The keyboard 6, as shown in FIG. 2, comprises a keypad 8 and an input assembly 10. The keypad 8 includes a plurality of key members 12 arranged in a key matrix. The input assembly 10 is arranged beneath the keypad 8 for converting a mechanical input applied to the keypad 8 to an electrical input to a printed circuit board (PCB) to generate a command signal to be passed to the portable computer.

The keypad 8 includes key members 12 and a plurality of corresponding resilient domed members 14 located beneath each key, as shown in FIG. 3. The resilient domed members 14 are preferably formed of rubber. Each key is supported on a scissors mechanism (not shown) which movably supports the key 12 in a first rest position such that it is movable to a second operative position. The scissors mechanism is arranged to collapse when the key 12 is depressed, and acts as a stabalising means for guiding and supporting movement of the keys 12. The scissor mechanism comprises two pivotally linked members, preferably formed of a plastic material, that interlock in a scissor-like fashion. The scissors snap-fit to the keyboard at their upper end and the key and snap fit at their base to a scissor support plate 11. The scissor support plate 11 is preferably formed from metal such as aluminium and includes snap-fit connection tabs 13 punched from the support panel 11 to which the scissors connect.

The domed members 14 are arranged beneath the keys 12 and supported on a dome support panel 15 which is located beneath the support panel 11 of the scissor mechanisms and is secured thereto in a laminar arrangement. A plunger portion 16 projects downwardly from the inner surface of the upper portion of the domed member 14. The scissor support panel 11 includes a plurality of apertures 17 corresponding to and arranged to receive the domed members 14 such that domed members 14 extend upwardly through the apertures 17 and supported at their base on the dome support panel 15. The dome support panel 15 includes a plurality of apertures 19 corresponding to the domed members 14, The apertures 19 are located beneath each domed member 14 and are configured such that they are smaller in diameter than the domed members 14 with the base of the domed members extending around the apertures 19, and sized to permit the plunger portion 16 to extend therethrough when the corresponding key 12 is pressed.

The lower surface of each key 12 includes an engagement lug which projects from the lower surface to engage the domed member 14 causing it to compress. The length of the engagement lug allows the key 12 to depress the domed member 14 with a much shorter travel than the typical rubber dome keyboard. The dome support plate 15 defines the base of the keypad assembly 8, and is preferably configured as a rigid structural member having a thickness of between 3 mm and 6 mm. As such, in order to contact the input assembly 10 which in use is located immediately beneath the support plate 15 the domed member 14 is configured such that the plunger portion 16 extends past the base or feet of the domed body portion to a position beneath the base defined by the thickness of the support plate 15.

As the key 12 pushes down against the domed member 14, the domed member 14 is pushed down also. The plunger portion 18 located within the dome is arranged such that when the dome is fully compressed the as the key moves to the operative position the plunger portion 18 engages the input assembly 10 located beneath the keypad 8 through the apertures 17 and 19 at a position beneath the base of the body of the domed member 14. When the key 12 is released, the resilient domed member 14 returns to its original position, disengaging the input assembly 10 and returning the key 12 to its original position.

The input membrane assembly 10 comprises a grid of circuits which are configured such that the circuits are broken at a plurality of discrete points or nodes. The nodes are arranged to correspond to the key matrix such that a node is located beneath each key 12. As shown in FIG. 4, the input assembly comprises an upper membrane 20, a lower membrane 22, and a spacer membrane 24 arranged between the upper membrane 20 and the lower membrane 22. The upper membrane 20 is formed from a flexible, non-conductive material such as polyethylene terephthalate (PET), and preferably a boPET such as Mylar®. A circuit 26 is provided on the lower surface of the upper membrane 20. The circuit may be provided on the lower surface 30 by means of printing using an electrically conductive ink, or any other suitable means. The circuit 26 comprises a plurality of nodes corresponding to the key matrix of the keypad 8.

The lower membrane 22 is formed from the same material as the upper membrane 20. The lower membrane 22 includes a circuit 34 on its upper surface 36 formed in the same manner as the circuit 26 of the upper membrane 20. The circuit 34 includes a plurality of nodes 35 which positionally correspond to the nodes of the upper membrane circuit 26. Both the upper membrane circuit 26 and lower membrane circuit 34 also include output tracks 40 respectively for connection to a PCB or other component of the laptop computer 1.

The non-conductive spacer membrane 24 is positioned between the upper membrane 20 and the lower membrane 22, and is formed from the same material as the upper and lower membranes 20 and 22, although this is not essential and other non-conductive materials may be used. The spacer membrane 24 electrically isolates the upper circuit 26 from the lower circuit 34. A plurality of apertures 44 are formed in the spacer membrane 24 at locations corresponding to the nodes 28 and 38 of the upper and lower membrane 20 and 22. The size of the apertures 44 is selected such that the nodes of the upper circuit 26 and lower circuit 34 aligned with the apertures are held spaced apart. Specifically, the diameter of the apertures 44 is selected such that the depth of sag of the upper membrane 20 within the aperture 44 is less than the thickness of the spacer membrane 24. Preferably the thickness of each membrane is 100 micrometers, but the width of the apertures 26 may be varied for varying membranes thicknesses and hence varying sag coefficients.

A processor monitors the key matrix for signs of continuity at any point on the grid. When it finds a circuit that is closed, it compares the location of that circuit on the key matrix to a character map in its ROM to determine the character to which the specific key corresponds.

The upper membrane 20, lower membrane 22 and spacer membrane are secured together to form the input membrane assembly 10. In three-membrane input assembly arrangements of the prior art, in which the membrane assembly is sandwiched within the keypad assembly 8 between the domed layer and the base, the three membranes are of equal size and are secured together and sealed around their periphery to form a watertight envelope. However, external component connections such as the connection tabs extend from and are not contained within the input assembly 10 and therefore remain vulnerable to exposure to liquids, as do the points of connection within the laptop. Furthermore, while the circuitry of the membrane assembly itself may be waterproof the internal circuitry of the laptop remains vulnerable to liquid flowing over the membrane assembly and into the laptop body in the event of a spill or otherwise.

The input membrane assembly 10 of the present invention is therefore removed from the keypad assembly 8 and provided as a discrete and separate element, detached from the keypad 8. The input membrane assembly 10 is sealed to a base member 42 as shown in FIG. 2, with the base 42 forming a further layer of the membrane assembly 10. The base member 42 is preferably a rigid member and is preferably formed from aluminium. The upper membrane 20 comprises a peripheral sealing surface on its lower surface which is adhered to the upper surface of the spacer membrane 24. Similarly, the spacer membrane 24 includes a sealing surface on its lower surface which is adhered to the upper surface of the lower membrane 22. In this way a sealed membrane assembly is formed in which the circuits of the upper and lower membranes 20,22 are sealed within the sealing perimeter defined by the sealing surfaces.

The membrane assembly defined by the upper 20, lower 22 and spacer membrane 24 is adhered to the base member 42. In the embodiment shown in FIG. 2 the membrane assembly 10 is adhered to the base 42 by a sealing surface defined substantially on the lower surface of the lower membrane 22, with the upper membrane 20 and spacer membrane 24 being substantially the same size as the lower membrane 22. The connection track 40 of the lower membrane 22 is located inboard of the periphery of the upper membrane 20 and spacer membrane 22 and extends downwardly towards the base 42. At this portion of the lower membrane 22 the sealing surfaces of the upper 20 and spacer 24 membranes are located outwardly of the tab 40. The resulting exposed portion of the lower surface of the spacer membrane 24 adhere to the base 40 to complete the sealing surface and to seal and encapsulate the connection tab between the membrane assembly 10 and the base 40.

An elongate slot 57 is defined in the base 42 and arranged to receive the downwardly extending connection tab 40. The tab 40 passes through the base 42 such that it distal end is available for connection to the laptop beneath the lower surface of the base 42. The slot 57 is located within the sealing perimeter of the seal between the membrane assembly 10 and the base 42 with the membrane assembly 10 forming a sealing blanket over and as such no liquid is able to pass through the slot 57 from the upper surface of the base 42.

In an alternative embodiment the upper membrane 20 may be larger than spacer 24 and lower 22 membranes having a larger footprint that extends past the periphery of the spacer 24 and lower 22 membranes with the overhanging portion defining a sealing surface which seals to the base 42 to seal and encapsulate the spacer 24 and lower 22 membranes and the connection tab 40 and corresponding connection slot 57.

As shown in FIG. 2, the base 42 comprises a rim portion 44 which includes an upstanding wall portion extending upwardly from the periphery of the base 42 and a substantially horizontal lip portion 46 extending from the wall portion. The rim portion 44 defines an open topped enclosure within which the input membrane assembly 10 is housed.

As shown in FIG. 6 frame section 50 surrounds the base section 42. The frame section 50 includes a front frame member 52 which is arranged towards the front of the laptop body relative to the base 42, a rear frame member 54 which in use is arranged towards the rear of the laptop body, and side members 56 which interconnect the front 52 and rear 54 members. The frame 50 is secured to the base 42.

As shown in FIG. 5, the frame 50 is moulded to the lip 56 of the base 42 defining a watertight seal between the frame 50 and the base 42 and securing the base 42 to the frame 50 such that they form a unitary component. A plurality of lugs 58 are arranged about the outer edge of the frame 50 defining connection points. An aperture 60 is formed in the upper panel 3 of the body section 2 to receive the keyboard assembly 6. The frame 50 is positioned relative to the upper panel 3 of the body section 2 such that the upper surface of the frame 50 is substantially flush with the upper surface of the upper panel 3 and such that is adjacent the inner edge of the aperture 60.

The upper panel 3 of the body section 2 includes a frame section 58 defining a cosmetic strip which is located above and extends around the upper surface of the frame 50. The cosmetic strip 61 extends inwardly as far as the inner edge of the frame 50 and outwardly past the outer peripheral edge 59 of the frame 50 defining an overhang. The overhanging section of the cosmetic strip extends to and sits on the upper panel 3 and bridges any gap between the frame 50 and the upper panel 3 to provide a more aesthetically pleasing finish. The frame 50 is screwed to the cosmetic strip 61 through the plurality connection points 58.

As shown in FIGS. 2 and 5 for example a gasket 62 is provided on the upper surface of the frame 50 which substantially corresponds to the shape of the upper surface and defines a sealing means for sealing between the frame 50 of the membrane assembly 8 and more specifically for sealing between the frame 50 and the cosmetic strip 61. As the frame 50 is screwed to the cosmetic strip 61 the gasket is clamped between the frame 50 and the cosmetic strip 61 to form a watertight seal therebetween. As such liquid is prevented from entering the laptop body between the frame and the cosmetic strip 61, and between the frame 50 and the base 42. A seal is also provided between the cosmetic strip 61 and the upper panel 3. As such, the entire upper surface of the laptop 1 is sealed and watertight. Any water poured onto the upper surface of the laptop 1 is prevented from entering the housing defined by the body by the seal between the input membrane assembly 10 and the base 42, the sealed arrangement between the base 42 and the frame 50, and the seal defined between the frame 50 and the cosmetic strip 61 by the gasket 62. In addition to being prevented from entering the laptop body 2 liquid ingress to the circuitry of the input membrane assembly 10 is also prevented by the sealed blanket arrangement of the membrane assembly 10.

In addition to facilitating the sealing arrangement between the base 42 and the laptop body 2 the frame 50 also provide a means for securing the keypad 8 to the laptop body 2. As shown in FIG. 3 the scissor support plate 11 includes an upstanding wall 71 around its periphery. A plurality of tabs 70 are arranged along the front edge of the support plate 11 at corresponding gaps in the wall 71. The tabs 70 extend upwardly from the support plate 11 and each includes a substantially horizontally oriented distal portion 74 which extends horizontally outwardly away from the front edge substantially perpendicular to the upstanding portion. A plurality of similar tabs 72 are arranged along the rear edge of the support plate 11 at corresponding gaps in the wall 71. The upstanding tabs 72 include distal end portions 76 which extend horizontally outwardly away from the rear edge. The front 70 and rear 72 tabs define connection portions.

The frame 50 includes a plurality of recesses 55 arranged along the inner edge of the front frame section 52. The recesses 55 can be seen in FIG. 7 with the upper portion 83 of front frame section 52 removed. The upper portion 83 caps the recesses 55 with its lower surface defining the roof of the recesses 55. The recesses preferably extend the entire height of the lower portion 81. The recesses 55 are configured to receive the front tabs 70. The height of the recesses 55 is substantially equal to the height of the upper surface of the When received within the recesses 55 of the frame 50 the tabs 70 are vertically restrained with the recess engaging tabs 70 as taken from the lower surface of the base 42. The height of the recesses 55 is such that the tabs 70 can be inserted into the recesses at a downwardly inclined angle before the base 42 is rotated downwardly substantially pivoting about its front edge until it horizontal in which position the upper surface of the distal end 74 of the tabs 70 abut the roof of the recesses 55 which prevents the tabs 70 from being lifted upwardly. In order to remove the tabs 70 from the recesses the keypad 8 must be pulled away from the front section 52 of the frame in substantially horizontal direction. The recesses are configured to permit downward movement of the tabs 70 and as such the keypad 8 may be lifted by its rear edge in a substantially arcuate motion pivoting about the front edge to remove the tabs 70 from the recesses.

The rear section 54 of the frame 50 includes clamping means for clamping the keypad 8 in position within the frame 50 relative to the input membrane assembly 10 with the keypad 8 being arranged in this clamped position such that the keys 12 are able to actuate the corresponding nodes of the input assembly 10. The clamping means comprise a plurality of clamping members arranged at spaced locations along the length of the frame member 54 corresponding to the location of the rear tabs 72. The clamping members 77 are rotationally mounted on a wire spindle as shown in the exploded view of FIG. 7. The rear frame section 54 comprises a two part construction having a lower portion 80 and an upper portion 82. The front frame section 52 also includes a lower portion 81 and an upper portion 83. Channels 84 are formed along the length of the lower surface of the upper section 82 and upper surface of the lower 80 portion which combine when the upper 82 and lower 80 are connected to define a single channel forming a rotational bush for the spindle. The lower portion 80 is moulded as part of the main body of the frame 50 and the upper portion 82 is moulded as a separate component. During assembly the spindle is inserted into the channel 84 and the upper 82 and lower 80 portions are then adhered together. A plurality of recesses are located along and length of the upper portion 82 and in the inner wall of the lower portion 80 which correspond to the locations along the length of the spindle 78 of the clamping members 77.

As can be seen in FIG. 8, each clamping member 77 includes a substantially cylindrical body 86 circular in cross section having a central bore through which the spindle 78 extends defining the axis of rotation of the clamping member 77. The spindle 78 includes a knurled portion or other surface feature coincident with each clamping member 77 configured to rotationally fix the clamping members 77 relative to the spindle, with the clamping members preferably being moulded about the spindle 78. A first clamping projection 88 extends substantially tangentially from an upper portion of the body section 86 having a lower clamping surface 90. A second release projection 92 is located at an angularly spaced location from the clamping projection 88 and extends substantially radially from the body section 86. The release projection 92 tapers towards its distal end radially away from the body section 86 and includes an upper release surface 94. A space is defined between the clamping projection 88 and the release projection 92 which is configured to receive the distal end or lip portion 76 of tabs 72 of the keypad 8.

A pair of release levers 96 are provide at the ends of the spindle 78, as shown in FIGS. 7 and 9 and are arranged substantially perpendicular to the longitudinal axis of the spindle 78 and are housed within the frame 50 such that they are able to rotate between a clamped position in which the levers are substantially parallel and preferably substantially flush with the upper surface 3 of the body section 2, as shown in FIG. 9, and a release position in which the levers are angled upwardly towards the front of the frame 50, as shown in FIG. 11. The levers 96 are rotationally fixed to the ends of the spindle 78 such that rotation of the levers 96 causes direct rotation of the spindle 78 and the clamping members 76.

The clamping members 76 are arranged on the spindle 78 such that when the levers 96 are in the clamped position, the clamping members 76 are also in the clamping position shown in FIG. 8 in which the clamping projection 88 extends substantially horizontally. As the levers 96 are lifted to the release position, pivoting about the pivot axis defined along the longitudinal axis of the spindle 78, the spindle is rotated in a rearward direction causing the clamping members 76 to rotate such the clamping projections 88 and the release projections 90 to move upwardly to the release position, in a rearward rotation, with the clamping members 76 and levers 96 rotating in the opposite direction when returning to the clamped position.

To clamp the keypad 8 to the base 50 of the input assembly 10 the clamping members are first rotated to the release position, as shown in FIG. 11. The keypad 8 is angled such that it is sloping downwardly towards its front edge which includes the tabs 70, and moved towards the front portion 52 of the frame 50 such that the tabs 70 are introduced into the recesses 55. The keypad 8 is then rotated downwardly about its front edge towards the input membrane assembly 10. The keypad 8 is rotated downwardly until the rear tabs 72 contact the release projections 90. The clamping members are configured such that when in the release position the release projection is located with the arc of rotation of the keypad 8 and the clamping projection is outside the arc such that it avoids contact with the keypad 8.

As the keypad 8 rotates further such that its rear edge continues to move downwards it remains in sliding engagement with the upper surface of the release projection 90, causing the projection 90 to rotate downwardly with the keypad 8 causing corresponding rotation of the clamping member. The release projection 90 is configured such that as the keypad 8 moves downwardly the engagement point with the release projection moves radially inwardly along the release projection 90. The keypad 8 continues to rotate as it is pushed downwardly until it engages and the input membrane assembly 10 in a substantially horizontal position parallel to the input membrane assembly 10. At this point the keypad 8 has rotated the clamping members 76 to a position in which the clamping projection 88 of each clamping member 76 engages and clamps against the upper surface of the corresponding tabs 72 to clamp the keypad 8 in position against the input membrane assembly 10 thereby securing the keypad to the body 2 of the laptop 1 via the frame 50 of the input assembly 10. The keypad 8 and the frame 50 are arranged such that when the keypad 8 is clamped it is held relative to the input membrane assembly 10 such that the keys 12 are able to cause the dome members to

The rotation of the clamping members 76 causes corresponding rotation of the levers 96 moving them to the clamped position. At least one of the levers preferably includes a catch or pawl member 102 which passes over a corresponding ratchet member or lug 104 on the frame 50 to hold the lever 96 and hence the clamping members 76 in the clamped position. The lever may also include a cam portion arranged to lift the pawl 102 over the ratchet member 104 as the lever is lifted towards the release position to release the clamping members 76.

To remove the keypad 8 the levers 96 are lifted from the clamping position causing the clamping projections 88 to rotate upwardly away from the clamped position releasing the keypad. In the clamped position the keypad 8 is located within the confines of the frame 50 and substantially below the upper surface 3 of the body section 2 to the laptop 1. Therefore removing the keypad 8 from the laptop once released could prove problematic as it would be difficult for a user to grip an edge of the keypad. The release projection 90 addresses this issue. As the clamping member rotates upwardly and rearwardly under the action of the lever 96 the release projection comes into contact with the lower surface of the tab 72 and begins to lift the tab 72 and hence the keypad 8 until in the fully rotated release position the rear edge of the keypad 8 is held proud above the upper surface 3 of the laptop 1 to enable it to be gripped. The keypad 8 may then be removed by the user.

As the keypad 8 itself comprises no electrical components no electrical disconnection from the laptop 1 is required. For the same reason the keypad 8 may be washed when removed in whatever manner is required, including full immersion in a body of liquid. The input membrane assembly 10 remains connected to the laptop 1, with the electrical circuits and electrical connection to the laptop 1 maintained and sealed beneath the blanket seal arrangement. Therefore, even with the keypad 8 removed and the input membrane assembly 10 exposed the laptop remains watertight.

It will be appreciated that in other embodiments other suitable clamping means may be used, and the term clamping means is intended to mean any means suitable for holding the keypad in engagement with or in a suitable position relative to the input assembly 10. For example, in an alternative embodiment a slide catch arrangement may be provided, comprising a sliding lock arrangement configured to slide between a first position in which the rear tabs of the frame are obstructed and retained, and a second position in which they are uncovered by the slide means for release.

In a further embodiment the domes 14 may be formed from a flexible, resilient material such as silicone including a luminescent additive such as zinc sulphate or strontium which is able to emit light following excitation by a light source. A light source is provided beneath the domes 14 which is arranged to illuminate at least part of the domes 14. The keys 12 are configured to include a transparent portion. When the domes 14 are excited by the light source beneath they begin to emit light which is transmitted through the transparent portions of the keys 12 such that the keys are illuminated or ‘backlit’. The light source may be an electroluminescent layer located beneath the domes 14 forming part of the input membrane assembly 10 and sealed as part of said assembly 8. Alternatively a plurality of LEDs may be provides beneath the base 42 with a corresponding plurality of apertures being formed in said base 42 with the perimeter of the input membrane assembly seal, such the LEDs are sealed by the membrane assembly 8. Other suitable means of illuminating the domes 14 may also be provided. This arrangement addresses the issue of how to backlight a keypad having domes and other structural layers beneath the keys which otherwise impeded or block the passage of light to the keys.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

It will be appreciated that in further embodiments various modifications to the specific arrangements described above and shown in the drawings may be made. For example, while the keyboard assembly of the present invention is described in use with a laptop, it will be appreciated the keyboard assembly may be applied to any application where a keypad is required to attach to a body containing electrical components in which it is required to remove and/or waterproof the keyboard. It will also be appreciated that while a specific frame arrangement is described above, the arrangement described may be put into practice with many of the components being positionally rearranged, and terms such as front, rear, up, down are intended to be relative and non-limiting.

1. A portable computer keyboard assembly comprising:
an input membrane assembly comprising first and second membranes each having an electrical circuit provided on a surface thereof, and means for separating the electrical circuits of the first and second membranes and permitting selective electrical connection therebetween at discrete contact nodes, the input membrane assembly being configured to be secured to the portable computer;
a keypad including a plurality of keys and a support member for movably supporting said keys such that the keys are movable between a first position and a second operable position, the keys being arranged to correspond in position to the location of the contact nodes on the input assembly, and the keypad being configured to be located relative to the input membrane such that movement of the keys to the operative positions causes said selective electrical connection between the circuits of the first and second membranes at the corresponding contact nodes; and
releasable securing means for releasably securing the keypad in said location relative to the input membrane assembly and relative to a portable computer to which the input membrane assembly is secured, and for permitting said keypad to be released from its position relative to the input assembly for cleaning and/or repair.

2. A portable computer assembly according to claim 1 wherein the input membrane assembly and keypad assembly are arranged such that when the keypad is released and removed from the securing means the input membrane assembly is able to remain secured and electrically connected to the laptop.

3. (canceled)

4. (canceled)

5. A portable computer keyboard assembly according to claim 1, wherein the releasable securing means comprises clamping means and wherein the clamping means is configured to be secured to the portable computer and comprises a clamping member which is movable between a first clamped position in which the clamping member engages and clamps the keypad in said location relative to the input membrane assembly and a second release position.

6. A portable computer keyboard assembly according to claim 5 wherein the securing means comprises an engagement member configured to be secured to the portable computer and configured to engage with a portion of the keypad assembly and to cooperate with the keypad assembly when so engaged to retain the keypad in said location relative to the input membrane assembly when the clamping member is in the clamped position, the keypad being able to disengage from the engagement member when the clamping member is in the release position.

7. A portable computer keyboard assembly according to claim 5 wherein the clamping means includes actuating means configured to be manually engaged by a user to cause the clamping means to move between the clamping and release positions, said actuating means being a lever which is configured to be rotated by the user and arranged such that rotation of the lever causes the clamping means to move between the clamping and release portions.

8. (canceled)

9. (canceled)

10. A portable computer keyboard assembly according to claim 9 wherein the clamping member comprises a lifting portion arranged such that when the clamping member is rotated to the release position the lifting portion engages and lifts the keypad to enable the keypad to be gripped for release.

11. A portable computer keyboard assembly according to claim 9 wherein the clamping means comprises a plurality of clamping members rotatably mounted to a spindle which is actuatable to rotate the clamping members between the clamped and release positions.

12. A portable computer keyboard assembly according to claim 1 wherein the input membrane assembly comprises:
an electrical connector connected to the electrical circuit of one or both of the electrical circuits of the first or second membranes and comprising a connection portion configured for electrical connection to the portable computer;
a base for supporting the membrane assembly; and
sealing means configured to seal the membrane assembly to the base to form a sealed unit which seals and encapsulates the electrical circuits of the membrane assembly and the connection portion of the electrical connector.

13. A portable computer keyboard assembly according to claim 12 wherein the sealing means defines a sealing perimeter and the connection portion of the electrical connector is arranged such that it is located within the sealing perimeter to be sealed and encapsulated by the sealing means when the sealing means is sealed to the further surface.

14. A portable computer keyboard assembly according to claim 13 wherein the base includes an aperture configured to receive a connection cable to electrically connect the connection portion of the input membrane with the portable computer, the aperture being located within the sealing perimeter with access for the connection cable being achievable through the aperture from beneath the base.

15. A portable computer keyboard assembly according to claim 14 further including sealing means for providing a seal between the input membrane assembly and the body of a portable computer to prevent liquid ingress into the body of the portable computer between the input membrane assembly and said body.

16. A portable computer keyboard assembly according to claim 15 wherein the input membrane assembly further comprises a frame section which substantially surrounds the base and is configured to secure to the body of the portable computer, said frame being sealingly connected to the base of the input membrane assembly and comprising said sealing means for sealing to the body of the portable computer.

17. A portable computer keyboard assembly according to claim 16 wherein the sealing means comprises a sealing gasket provided on the upper surface of the frame for engagement with the portable computer, the frame comprising connection means for connecting the frame to the portable computer body such that the gasket is clamped therebetween.

18. A portable computer keyboard assembly according to claim 17 wherein the base comprises and upstanding wall portion extending about its peripheral edge including a rim portion which is secured to the frame section.

19. (canceled)

20. (canceled)

21. A portable computer keyboard assembly according to claim 12 wherein the releasable securing means comprises a clamping member which is movable between a first clamped position in which the clamping member engages and clamps the keypad in said location relative to the input membrane assembly and a second release position and securing means comprising an engagement member, one of the frame and the keypad assembly comprising a projection defining an engagement member and the other comprising a recess configured to receive said engagement member, the recess and projection being arranged to cooperate such that when the engagement member is received within the recess and the clamping member is in the clamped position the engagement member is locked within the recess to retain the keypad in said location relative to the input membrane assembly and when the clamping member is in the release position the engagement member is able to be removed from the recess to permit separation of the keypad from the input assembly.

22. (canceled)

23. An input assembly for a human interface device such as a keyboard; the input assembly comprising:
a keypad including a plurality of keys movable between a first position and a second operable position; and
input means for converting movement of the keys to the operable position to an electrical signal; and
releasable securing means operable such that in a first condition it secures the keypad relative to the input membrane assembly and in a second condition it allows the keypad and the input membrane assembly to be separated.

24. An input assembly according to claim 23 wherein the releasable securing means comprises clamping means.

25. An input assembly according to claim 24 wherein the clamping means is configured to be secured to a portable computer and comprises a clamping member which is movable between a first clamped position in which the clamping member engages and clamps the keypad in said location relative to the input membrane assembly and a second release position.

26. An input assembly according to claim 25 wherein the securing means comprises a least one engagement element configured to be secured to the portable computer and configured to engage with a portion of the keypad assembly and to cooperate with the keypad assembly when so engaged to retain the keypad in said location relative to the input membrane assembly when the clamping member is in the clamped position, the keypad being able to disengage from the engagement element when the clamping member is in the release position.

27. An input assembly according to claim 26 wherein the input means comprises a base plate and the clamping means comprises a frame arranged about the base plate and sealingly secured thereto the frame being arranged to receive the keypad and a portion of the frame comprising at least one recess defining said engagement element which is configured to receive a corresponding portion of the keypad to retain the keypad within the frame when the clamping member is in the clamped position.

28. An input assembly according to claim 25 wherein the clamping means includes actuating means configured to be manually engaged by a user to cause the clamping means to move between the clamping and release positions, said actuating means being a lever which is configured to be rotated by the user and arranged such that rotation of the lever causes the clamping means to move between the clamping and release positions.

29. (canceled)

30. (canceled)

31. An input assembly according to claim 28 wherein the clamping means comprises a clamping member which includes a lifting portion arranged such that when the clamping member is rotated to the release position the lifting portion engages and lifts the keypad to enable the keypad to be gripped for release.

32. An input assembly according to claim 31 further comprising a release member arranged such that when the keypad is moved relative to the input membrane assembly it engages the release member and causes the release member to rotate the clamping member to the clamped position to clamp the keypad in said position relative to the input membrane assembly.

33. (canceled)

34. An input assembly according to claim 25 wherein the clamping means comprises a plurality of clamping members rotatably mounted to a spindle which is actuatable to rotate the clamping members between the clamped and release positions.

35. A portable computing device comprising:
a body section containing electronic components of said computing device;
a keyboard assembly; and
sealing means arranged to provide a seal between the keyboard assembly and the body section to prevent liquid ingress into the body section between the keyboard assembly and the body section.

36. A portable computing device according to claim 35 wherein the keyboard assembly comprises:
a keypad including a plurality of keys movable between a first position and a second operable position; and
input assembly including electrical means for converting movement of the keys to the operable position to an electrical signal and a base, said input means being sealed to said base such that liquid ingress to the electrical means is prevented;
wherein said sealing means is arranged to form a seal between the base and the body section.

37.-44. (canceled)
